(19) United States
(12) Patent Application Publication
(10) Pub. No.: US 2021/0212544 A1
(43) Pub. Date: Jul. 15, 2021

(54) SCOURING ARTICLE WITH MIXTURE OF ABRASIVE PARTICLES

(71) Applicant: 3M INNOVATIVE PROPERTIES COMPANY, St. Paul, MN (US)

(72) Inventors: Lijun ZU, Woodbury, MN (US); David C. RAITHEL, Hudson, WI (US)

(73) Assignee: 3M Innovative Properties Company, St. Paul, MN (US)

(21) Appl. No.: 17/054,839

(22) PCT Filed: May 15, 2019
(86) PCT No.: PCT/IB2019/054044

§ 371 Date: Nov. 12, 2020

Related U.S. Application Data
(60) Provisional application No. 62/672,875, filed on May 17, 2018.

(51) Int. Cl. A47L 13/16; A47L 17/08; C09K 3/14; D04H 1/22; D04H 1/4342; D04H 1/4382; D06M 11/76; D06M 15/41

(52) U.S. Cl. CPC A47L 13/16; A47L 17/08; C09K 3/1409; D04H 1/22; D04H 1/732; D04H 1/43835; D06M 11/76; D06M 15/41; D04H 1/4342

(57) ABSTRACT

A scouring article include a three-dimensional non-woven web of fibers bonded to one another to form a lofty, non-woven substrate. An abrasive coating is coated on the substrate. The abrasive coating includes a binder; a first plurality of abrasive particles and a second plurality of abrasive particles dispersed in the binder. The first plurality of inorganic abrasive particles has a Mohs' hardness of 7 greater and a median particle size in the range of 20 microns to 100 microns. The second plurality of organic abrasive particles has a Mobs' hardness in the range of 1 to 5 and a median particle size greater than 100 microns. The average surface roughness created by use of the scouring article, according to the surface roughness test, is less than 8 microns.

### FIELD OF THE INVENTION

The present disclosure relates to scouring articles for use in removing food or other debris from a surface.

### BACKGROUND

Non-woven scouring articles can be used for a variety of purposes. For example, a scouring article can be used to remove build-up of coatings or other materials on a floor, to remove baked-on food or other debris from a cooking surface or a dish, and for general cleaning purposes. There is opportunity to provide a non-woven scouring article with improved abrasion features.

### SUMMARY

Non-woven scouring articles are generally comprised of fibers bonded together to form a lofty or open web. The web of fibers is then coated with an abrasive coating. In some instances, an abrasive coating can contain particles that are both too large and too hard. This means that abrasive particles are harder than (as measured by Mohs' hardness or other similar hardness measurements) the surface the scouring article is being used to scour. When these relatively hard particles are also large (as can be measured by median particle size), the particle can leave visible scratches behind on the surface which was scoured.

The present disclosure solves the challenges of effective and non-damaging scouring by providing a scouring article with a mixture of particles, wherein a first plurality of particles has a greater hardness and a smaller size, and the second plurality of particles has a lesser hardness but a larger size. Even though the second plurality of particles may have a substantially lower hardness than the surface the scouring article is used to scour, the combination of particles in the scouring article of the present disclosure have been found to have surprising benefits in effectively removing unwanted food or other debris from a surface without damaging the surface.

In one instance, the present disclosure comprises a scouring article. The scouring article comprises a three-dimensional non-woven web of fibers bonded to one another to form a lofty, non-woven substrate and an abrasive coating on the substrate. The abrasive coating comprises a binder, a first plurality of inorganic abrasive particles, and a second plurality of organic abrasive particles. The first plurality of inorganic abrasive particles having a Mohs' hardness of 7 or greater dispersed in said binder, wherein the abrasive particles have a median particle size in the range of 20 microns to 100 microns. The second plurality of organic abrasive particles having a Mohs' hardness in the range of 1 to 5 dispersed in the binder, wherein the organic abrasive particles have a median particle size greater than 100 microns. The average surface roughness created by use of the scouring article, according to the surface roughness test, is less than 8 microns.

In another instance, the present disclosure comprises a method of making a scouring article. The method includes the steps of: (a) coating a lofty non-woven substrate with an abrasive slurry; and (b) subjecting the abrasive slurry to conditions sufficient to at least partially cure the binder. The abrasive slurry comprises a binder, a first plurality of inorganic abrasive particles, and a second plurality of organic abrasive particles. The first plurality of inorganic abrasive particles having a Mohs' hardness of 7 or greater dispersed in said binder, wherein the abrasive particles have a median particle size in the range of 20 microns to 100 microns. The second plurality of organic abrasive particles having a Mohs' hardness in the range of 1 to 5 dispersed in the binder, wherein the organic abrasive particles have a median particle size greater than 100 microns. The average surface roughness created by use of the scouring article, according to the surface roughness test, is less than 8 microns.

In another instance, the present disclosure includes a roll comprising a three-dimensional non-woven web of fibers bonded to one another to form a lofty, non-woven substrate and an abrasive coating on the substrate, wherein the substrate is wound about itself to form a roll; and wherein the substrate is perforated across its width at regular intervals such that a section of the substrate can be removed from the remainder of the substrate and used as a single scouring pad. The abrasive coating comprises a binder, a first plurality of inorganic abrasive particles having a Mohs' hardness of 7 greater or dispersed in said binder, wherein the abrasive particles have a median particle size in the range of 20 microns to 100 microns; and a second plurality of organic abrasive particles having a Mohs' hardness in the range of 1 to 5 dispersed in the binder, wherein the organic abrasive particles have a median particle size greater than 100 microns;

In some instances, the weight of the organic abrasive particles is at least 4% of the total weight of the scouring article.

In some instances, the combined weight of the organic abrasive particles and the inorganic abrasive particles is in the range of 20-65% of the weight of the scouring article.

In some instances, the fibers are melt-bonded to one another at their mutual contact points.

In some instances, the fibers are bonded to one another at their mutual contact points by a pre-bond resin.

In some instances, the abrasive coating extends throughout a thickness of the substrate.

In some instances, the abrasive coating is concentrated near a surface of the substrate.

In some instances, wherein the binder comprises at least one of acrylic resin, phenolic resin, nitrile resin, ethylene vinyl acetate resin, polyurethane resin, polyurea or urea-formaldehyde resin, isocyanate resin, styrene-butadiene resin, styrene-acrylic resins, vinyl acrylic resin, aminoplast resin, melamine resin, polyisoprene resin, epoxy resin, ethylenically unsaturated resin, and combinations thereof.

In some instances, the fibers comprise materials selected from the group consisting of polyamide, polyolefin, polyester, poly-lactic acid (PLA), cotton, rayon, kenaf, cellulose, metal and combinations of the foregoing.

In some instances, the inorganic abrasive particles comprise at least one of boron carbide, cubic boron nitride, fused aluminum oxide, ceramic aluminum oxide, heat treated aluminum oxide, alumina zirconia, silicon carbide, iron oxides, tantalum carbide, cerium oxide, garnet, titanium carbide, synthetic and natural diamond, zirconium oxide, silicon nitride, or combinations thereof.

In some instances, the organic abrasive particles comprise at least one of melamine-formaldehyde resin, phenolic resin, polymethyl methacrylate, polystyrene, polycarbonate, certain polyesters and polyamides, and the like, or combinations thereof.

In some instances, the weight of the organic abrasive particles is at least 4% of the total weight of the slurry.

In some instances, the combined weight of the organic abrasive particles and the inorganic abrasive particles is in the range of 20-65% of the weight of the scouring article.

In some instances, the roll further comprises a polymer packaging formed to the exterior surface of the roll.

In some instances, the packaging provides access to remove the scouring article from one end of the roll, such that sections of the scouring article can be removed without destroying the overall integrity of the polymer packaging and the remaining roll.

### BRIEF DESCRIPTION OF THE DRAWINGS

The invention may be more completely understood when considered with the following detailed description in connection with the accompanying drawings, in which:

FIG. 1 shows a scouring article with a mixture of abrasive particles.

FIG. 1a shows an enlarged view of a scouring article with a mixture of abrasive particles.

FIG. 2 shows a process of making a scouring article with a mixture of abrasive particles.

FIGS. 3A and 3B show a roll of scouring articles with a mixture of abrasive particles.

The embodiments shown and described herein may be utilized and structural changes may be made without departing from the scope of the invention. The figures are not necessarily to scale. Like numbers used in the figures refer to like components. However, the use of a number to refer to a component in a given figure is not intended to limit the component in another figure labeled with the same number.

### DETAILED DESCRIPTION

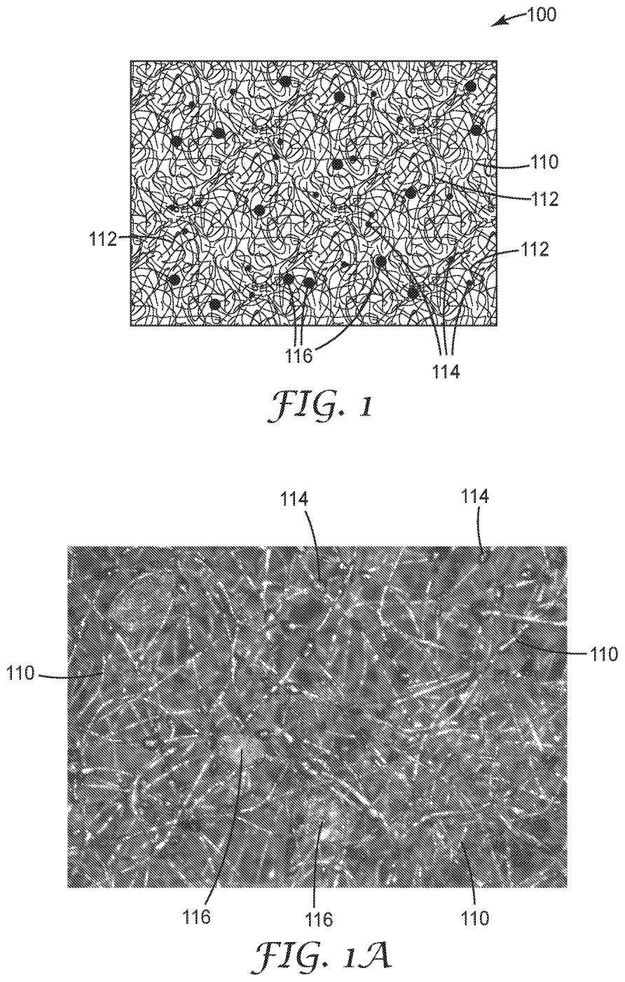

FIG. 1 shows a scouring article 100 with a mixture of abrasive particles consistent with the present disclosure. Scouring 100 includes a three-dimensional non-woven web of fibers 110 bonded to one another to form a lofty, non-woven substrate. A variety of fibers 110 can be used consistent with the present disclosure, including natural and synthetic fibers. In some instances the fibers 110 may include materials selected from the group consisting of polyamide, polyolefin, polyester, cotton, rayon, kenaf, cellulose, metal and combinations of the foregoing. Additional, fibers include vegetable fibers, such as coco, sisal and hemp fibers. Other natural fibers include jute, flax and wool. Other synthetic fibers include polypropolene, acrylic (formed from a polymer of acrylonitrile), acetate, carbon fibers and glass fibers. Fibers 110 may be virgin fibers or waste fibers reclaimed from garment cuttings, carpet manufacturing, fiber manufacturing, or textile processing, and so forth. Fibers 110 can have any desired diameter, texture or length. Fibers 110 may also include biodegradable fibers, such as polylactic acid (PLA) fibers. In one instances, fibers 110 may have a length in the range of 3 cm to 30 cm.

Fibers 110 can be entangled together to form a loose web through a manufacturing process, such as needle-tacking, carding, air-lay, or hydroentanglement. The web of fibers can then be bonded to provide structural integrity. In some instances, the fibers 110 may be bonded together at their mutual contact points 112 by a pre-bond resin. In other instances, fibers may be melt-bonded to one another at their mutual contact points 112.

Examples of materials used in a pre-bond resin, consistent with the present disclosure, include thermosetting resins, including formaldehyde-containing resins, such as pheno formaldehyde, novalac phenolics and those with added crosslinking agents, phenoplasts, and aminoplasts; unsaturated polyester resins; vinyl ester resins; alkyd resins, allyl resins; furan resins, epoxies; polyurethanes; and polyimides. A pre-bond resin may also include, for example, acrylic resin, phenolic resin, nitrile resin, ethylene vinyl acetate resin, polyurea or urea-formaldehyde resin, isocyanate resin, styrene-butadiene resin, styrene-acrylic resins, vinyl acrylic resin, aminoplast resin, melamine resin, polyisoprene resin, ethylenically unsaturated resin, and combinations thereof.

The web formed of fibers 110 can range in dimension, depending on desired thickness and capacity of the machine forming the web. As an example, a machine such as a “Rando-Webber” device, obtained from Rando Machine Co., located in Macedon, N.Y., may be used to form a web consistent with the present disclosure. In one instance, the web may have a thickness of 5 mm or greater. The density of the web can range, based on the fibers selected, machine and other variables. In one instance, the web may have a density of less than 50 kg/m³, or less than 30 kg/m³.

After fibers 110 are formed into a web or substrate, an abrasive coating can be applied to the substrate. The abrasive coating includes at least a binder; a first plurality of inorganic particles 114; and a second plurality of organic particles 116.

A binder consistent with the present disclosure can include a variety of materials. For example, a binder may include acrylic resin, phenolic resin, nitrile resin, ethylene vinyl acetate resin, polyurethane resin, polyurea or urea-formaldehyde resin, isocyanate resin, styrene-butadiene resin, styrene-acrylic resins, vinyl acrylic resin, aminoplast resin, melamine resin, polyisoprene resin, epoxy resin, ethylenically unsaturated resin, and combinations thereof.

Inorganic particles 114 may include a wide range of particles, such as boron carbide, cubic boron nitride, fused aluminum oxide, ceramic aluminum oxide, heat treated aluminum oxide, alumina zirconia, silicon carbide, iron oxides, tantalum carbide, cerium oxide, garnet, titanium carbide, synthetic and natural diamond, zirconium oxide, silicon nitride, or combinations thereof.

Inorganic particles 114 may also include agglomerates, a particle that is formed when a plurality of abrasive particles are bonded together with a binder to form a larger abrasive particle, which may have a specific particulate structure. The plurality of particles which form the agglomerate may comprise more than one type of abrasive particle.

The hardness of inorganic particles 114 may vary. In some instances, inorganic particles have a Mohs' hardness of 7 or greater, 8 or greater, 9 or greater or 10 or greater. Inorganic particles may have a range of shapes and sizes. Because, in some instances, inorganic particles 114 are harder than a surface that a scouring pad 110 is used to scour or clean, it can be advantageous for inorganic particles 114 to have a relatively small median diameter to reduce visible scratching that may occur on the surface. For example, inorganic particles 114 may have a median particle size of less than 150 microns, 100 microns, 75 microns, 50 microns, 40 microns, 30 microns, 25 microns, 20 microns or 10 microns. The median particle size of the inorganic particles 114 may be smaller than the median particle size of the organic particles 116, though it is possible that some of the inorganic particles 114 may simultaneously have a larger diameter than particles some of the organic particles 116, depending on particle size distribution of each of the inorganic particles 114 and organic particles 116.

Organic abrasive particles 116 may include a variety of materials. For example, organic abrasive particles 116 may include or be made from: at least one of melamine-formaldehyde resin, phenolic resin, polymethyl methacrylate, polystyrene, polycarbonate, certain polyesters and polyamides, and the like, or combinations thereof.

Organic particles 116 may vary in hardness. For example, in some instances, organic particles may have a Mohs hardness in the range of 1 to 5. In another instance, organic particles may have a Mohs' hardness in a range of 2 to 5; 3 to 5; 2 to 4; or 2 to 3. The lower relative hardness of organic particles 116 to a surface that a scouring pad consistent with the present disclosure may be used to cure can help to ensure that while the organic particles may be effective at removing food soil or other debris from a surface, organic particles 116 do not leave, or leave minimal, visible scratches on a surface or workpiece.

Organic abrasive particles 116 may have a range of sizes. For example, organic abrasive particles 116 may have a median particle size in the range of 50 microns to 1500 microns. In some instances, the range may be 100 microns to 1000 microns; 250 microns to 750 microns; or simply greater than 100 microns.

The large median particle size of organic abrasive particles 116, can increase cutting or abrasion efficacy when removing food soil or other debris from a surface or work piece.

Inorganic particles 114 and organic particles 116 are disbursed in a binder as discussed herein to form an abrasive slurry or coating. The abrasive slurry or coating can then be coated onto the fiber web using a method such as roll coating or spray coating. A spray coating method may be more efficient, in that a side of the web may be coated while requiring less abrasive coating than if the web was coated using a roll coating method. When the web or substrate is coated using a spray coating process, the abrasive coating is typically concentrated near the surface of the web or substrate. When the web or substrate is coated using a roll coating process, the abrasive coating is distributed throughout the thickness of the web. In some instances, a roll-coated web may be more durable than a spray coated web.

The coated abrasive web can then be converted into scouring articles fit for individual use. Scouring articles consistent with the present disclosure may have any shape or size useful for scouring using a machine or by hand. In one instance, a coated abrasive web may be perforated at regular intervals and rolled around itself to create a roll where a user can remove an individual scouring article for use by tearing at the perforations.

A scouring pad consistent with the present disclosure may contain additional elements and variations on the present disclosure, such as filler particles in the abrasive coating, another substrate laminated to one side of the scouring pad, such as foam or sponge, a texture created in a surface of the scouring pad using a method such as heat treatment (such as disclosed in United States Patent Publication No. 2017/0051442 to Endle et al., incorporated herein by reference), a printed image, brand information or instructions on a surface of the pad (such as disclosed in PCT Publication No. WO2017187320 to Gorrell et al., incorporated herein by reference.)

FIG. 1a shows an enlarged view of a scouring article 100 with a web of fibers 110, organic particles 116 and inorganic particles 114.

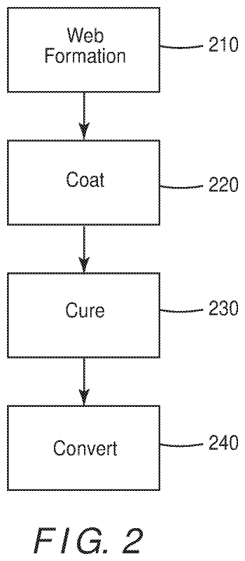

FIG. 2 shows a process of making a scouring article with a mixture of abrasive particles. Step 210 includes web formation. A lofty, non-woven substrate made from entangled fibers may be formed using a commercially available web formation machine, such as a “Rando-Webber” device, obtained from Rando Machine Co., located in Macedon, N.Y. A non-woven web consistent with the present disclosure may have entangled fibers, may be needle-tacked or have a pre-bond resin to impart initial structural integrity, and may be made using a variety of processes as set forth in U.S. patent application Ser. No. 10/554,213, Publication No. US2007/0026754 to Rivera et al., incorporated herein by reference.

Step 220, coating, includes coating the web or substrate with an abrasive coating or abrasive slurry. The abrasive coating includes a binder; a first plurality of inorganic abrasive particles; and a second plurality of organic abrasive particles. The binder, inorganic abrasive particles, and organic abrasive particles may have the attributes as discussed herein. The web may be coated using a variety of methods as will be apparent to one of skill in the art upon reading the present disclosure, including, for example, spray coating, roll coating, or dry mineral dropping.

Step 230, curing, includes subjecting the abrasive slurry to conditions sufficient to at least partially cure the binder. Such conditions may include heat, UV light, subjecting the web to certain gases or simply allowing the coating to dry by exposure to air.

Step 240, converting, can include cutting the web using a blade or other means to create individual scouring pads fitting for hand or machine use. Step 240 can also include cutting long strips of web with perforations at regular intervals, winding the web around itself or a center core to create a roll, wherein individual sections of the web can be manually removed to each form an individual scouring pad. An individual section may be removed from the center of the roll or the exterior of the roll.

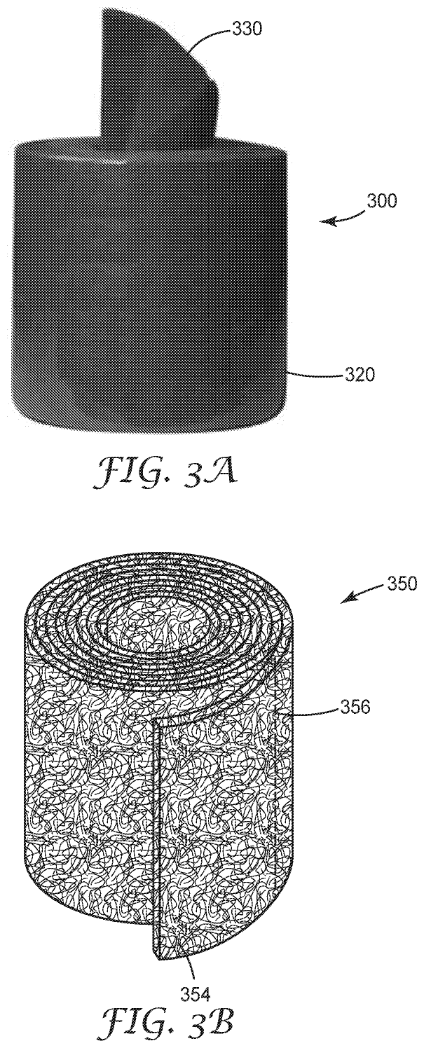

FIGS. 3A and 3B each show a roll of scouring articles with a mixture of abrasive particles. FIG. 3A shows a roll of scouring articles 300 with a polymer shrink-wrapped packaging 320 formed to the exterior of the roll. A range of packaging materials may be used, including, for example, polyolefin, polyvinyl chloride, polyethylene, polypropylene, and polyimide. In some instances, the packaging provides access to remove an individual scouring article 330 from one end of the roll, such that sections of the scouring article can be removed without destroying the overall integrity of the polymer packaging and the remaining roll.

FIG. 3B shows a roll 350 comprising a three-dimensional non-woven web of fibers bonded to one other to form a lofty, non-woven substrate, and coated with an abrasive coating or slurry consistent with the present disclosure. The web or substrate is wound about itself to form a roll; and is perforated across its width at regular intervals such that a section of the substrate can be removed from the remainder of the substrate and used as a single scouring pad. Perforation 356 is repeating throughout the length of the substrate to allow individual sections 354 of the substrate to be removed and used as scouring pads.

### Examples

Example Preparation

The following process was used to make scouring pads.

Non-Woven Web Formation

The nonwoven web was formed using a Rando air-laid nonwoven machine (Model SBD, Rando Machine Corp. Macedon, N.Y.). This process consists of 2 Rando feeders to open and blend the fiber followed by a Rando-Webber to create the air-laid nonwoven web. The fibers used in each of the Example as specified below with respect to each example. The fibers were 15 denier in average. The non-woven web was prepared using either nylon or polyester staple fibers combined with melty fibers, as specified in each Example below.

Preparation of Prebond

Some nonwoven webs were passed through a standard through air oven at temperature of 300 F for about 3 minutes. Some nonwoven webs were coated with a pre-bond resin with the formulation described below. The pre-bond binder formulation was dried using a standard through air oven. After drying, the samples were wound to prepare for the next treatment step. The web at this step is referred to as a prebond web.

The prebond binder formulation was prepared by mixing together 18.56 lbs of AMSCO resin 5900 (Myllard Creek Polymers, North Carolina USA), 1.89 lbs of Cymel 303 (Cytec Industries, New Jersey, USA), 3.95 lbs of calcium carbonate (Omycarb; Omya Canada, Perth Ontario, CA), 4.81 lbs of water. The viscosity of the mixture was approximately 1100 cps.

Construction of the Final Pad

In this final step, another binder solution containing abrasive particles was sprayed onto the prebond web formed in the previous step. The formulations of the spray coat are described below:

The spray Coat Formulation 1 was prepared by mixing together 9.47 lbs of phenolic resin (obtained from Neste Resins, Canada, under the trade designation BB077), 3.12 lbs of calcium carbonate (Omycarb; Omya Canada, Perth Ontario, CA), 0.16 lbs of cabosil M-5 (from Cabot Corporation), 9.04 lbs of water, 14.0 lb of grade 240 aluminum oxide abrasive minerals (obtained from Mico Abrasivos, Mexico), and 4 lbs of MC 30/40 granulated plastic blast media (from Maxi Blast Inc. under the trade name of Maxi-Clean).

The spray coat formulation 2 was prepared by mixing together 9.47 lbs of phenolic resin (obtained from Neste Resins, Canada, under the trade designation BB077), 3.12 lbs of calcium carbonate (Omycarb; Omya Canada, Perth Ontario, CA), 0.16 lbs of cabosil M-5 (from Cabot Corporation), 9.04 lbs of water, and 18.0 lbs of grade 240f aluminum oxide abrasive minerals (obtained from Mico Abrasivos, Mexico).

Example 1: Example 1 contained a blend of 75% 15 denier nylon staple fiber (EMS HT Nylon) and 25% 15d bicomponent low melt binder fiber (Huvis 110C melty fiber) with a total weight of approximately 100 gsm. The non-woven web formed using Rando air-laid machine was passed through a standard through air oven at a temperature of 300 F for about 3 mins. Then, both sides of the prebond web were coated with spray coat formulation #1 with a total dry add-on weight of approximately 200 gsm.

Example 2: Example 2 contained a blend of 50% 15 denier nylon staple fiber (EMS HT Nylon) and 50% 15d bicomponent low melt binder fiber (Huvis 110C melty fiber) with a total weight of approximately 50 gsm. The non-woven web formed using Rando air-laid machine were passed through a standard through air oven at a temperature of 300 F for about 3 mins. Then, both sides of the prebond web were coated with spray coat formulation #1 with a total dry add-on weight of approximately 200 gsm.

Example 3: Example 3 contained a blend of 75% 15 denier PET staple fiber (Stein recycled PET) and 25% 15d bicomponent low melt binder fiber (Huvis 110C melty fiber) with a total weight of approximately 100 gsm. The nonwoven formed using the Rando air-laid nonwoven machine was then sent through a roll coater to apply the binder formulation shown in Table 1 with a dry add-on weight of approximately 100 gsm. The binder formulation was dried using a standard through air oven at a temperature of 300 F for about 3 minutes. Then, both side of the prebond web were coated with spray coat formulation #1, with a total dry add-on weight of approximately 200 gsm.

Comparative Example 1: Comparative Example 1 was made according to the same procedure as Example 1 except the spray coat formulation 2 was used.

Comparative Example 2: Comparative Example 2 was made according to the same procedure as Example 2 except the spray coat formulation 2 was used.

Comparative Example 3: Comparative Example 3 was made according to the same procedure as Example 3 except the spray coat formulation 2 was used.

Performance Testing:

Food Soil Testing: Food Soil testing was performed using a metal plate with a blended food soil composition baked thereon, in generally similar manner as described in U.S. Pat. No. 5,626,512 to Palaikis. The test was performed manually rather than with the mechanized turntable used by Palaikis. A scouring article to be tested was placed atop the baked-on layer of food soil, and gentle manual pressure was applied. The scouring article was moved back and forth in linear fashion across an area of the baked-on food soil, with each movement back and forth being one scouring cycle. The number of scouring cycles required to remove enough food soil to expose a readily visually discernible area of the metal plate underlying the food soil was recorded (the test was terminated at 40 cycles if no metal was exposed). At least five different human operators perform the testing, with the results being averaged. The results are reported in number of scouring cycles to completely remove food soil in a visually discernible area.

Examples 1-3 were tested in comparison to above-described Comparative Examples 1-3. Table 1 shows the results of food soil test. In Table 2, the Total Weight is the area weight (in gram per square meter) of the Scouring article, inclusive of the binder and the scouring bodies. The Weight of the abrasive particles is based on the area weight as well.

The Food Soil Test is indicative of the ability of a scouring article to remove baked-on food soil from a test surface (with lower numbers indicating fewer scouring cycles needed to remove the baked-on food soil). It clearly showed that Examples 1-3 containing large organic particles have better performance on food soil removal than the Comparative Examples only containing smaller inorganic abrasive particles.

TABLE 1

| | Example | Comparative | Example | Comparative | Example | Comparative |
|---|---|---|---|---|---|---|
| | 1 | Example 1 | 2 | Example 2 | 3 | Example 3 |
| Total Wt. (gsm) | 300 | 300 | 250 | 250 | 400 | 400 |
| Wt. of the Organic | 28.6 | 0 | 28.6 | 0 | 28.6 | 0 |
| Abrasive Particles, | | | | | | |
| (gsm) | | | | | | |
| Wt. of Total | 129 | 129 | 129 | 129 | 129 | 129 |
| Abrasive Particles, | | | | | | |
| (gsm) | | | | | | |
| Food Soil Test | 9 | 39.4 | 6 | 37 | 8.22 | 18.6 |
| (cycles) | | | | | | |

Scratch Analysis (Surface Roughness Test)

Scratch level was determined by measuring the surface roughness of a stainless-steel panel after abrading by Examples 1-3, and Comparative Examples 1-3. A Gardner Heavy Duty Wear Tester was used for abrading stainless steel panel with above Examples under a controlled pressure. A mobile roughness measuring instrument MarSurf M-500 (from Mahr Federal Inc., RI) was used to measure the surface roughness.

A 6.4 cm by 19 cm stainless-steel panel was secured to an abrasion boat of a Gardner Wear Tester. The nonwoven scouring pad was inserted into the holder. Each of the Examples was then run back and forth to the smooth stainless-steel panel under an applied force of 2.25 kg for 25 cycles (back and forth equals one cycle). The stainless-steel panel was removed from the abrasion boat and its surface roughness was recorded. Three stainless-steel panels were tested and three locations on each panel were measured. The average of the 9 surface roughness values are listed in Table 2, including the initial surface roughness value. In the table below, Ra (average surface roughness) is the average of a set of individual measurements of a surface's peaks and valleys. Rz is the average maximum peak to valley of five consecutive sampling lengths within the measuring length. Rmax is the largest single roughness depth within the evaluation length. Examples 1 and 3 with larger organic abrasive particles have similar or lower scratch level when compared to the Comparative Examples.

TABLE 2

| | | Example | Comparative | Example | Comparative | Example | Comparative |
|---|---|---|---|---|---|---|---|
| | Initial | 1 | Example 1 | 2 | Example 2 | 3 | Example 3 |
| Ra, μm | 3.5 | 5.57 | 5.94 | 5.02 | 5.35 | 5.07 | 5.56 |
| Rz, μm | 37 | 48.57 | 53.13 | 50.43 | 49.88 | 49.56 | 50.67 |
| Rmax, μm | 46 | 70.57 | 75.63 | 77.86 | 76.47 | 66.89 | 69.89 |

What is claimed is:

1. A scouring article comprising:
a three-dimensional non-woven web of fibers bonded to one another to form a lofty, non-woven substrate;
an abrasive coating on the substrate, the abrasive coating comprising:
a binder;
a first plurality of inorganic abrasive particles having a Mohs' hardness of 7 or greater dispersed in said binder, wherein the abrasive particles have a median particle size in the range of 20 microns to 100 microns; and
a second plurality of organic abrasive particles having a Mohs' hardness in the range of 1 to 5 dispersed in the binder, wherein the organic abrasive particles have a median particle size greater than 100 microns;
wherein the average surface roughness created by use of the scouring article, according to the surface roughness test, is less than 8 microns.

2. The scouring article of claim 1, wherein the fibers are melt-bonded to one another at their mutual contact points.

3. The scouring article of claim 1, wherein the fibers are bonded to one another at their mutual contact points by a pre-bond resin.

4. The scouring article of claim 1, wherein the binder comprises at least one of acrylic resin, phenolic resin, nitrile resin, ethylene vinyl acetate resin, polyurethane resin, polyurea or urea-formaldehyde resin, isocyanate resin, styrene-butadiene resin, styrene-acrylic resins, vinyl acrylic resin, aminoplast resin, melamine resin, polyisoprene resin, epoxy resin, ethylenically unsaturated resin, and combinations thereof.

5. The scouring article of claim 1, wherein the fibers comprise materials selected from the group consisting of polylactic acid (PLA), polyamide, polyolefin, polyester, cotton, rayon, kenaf, cellulose, metal and combinations of the foregoing.

6. The scouring article of claim 1, wherein the inorganic abrasive particles comprise at least one of boron carbide, cubic boron nitride, fused aluminum oxide, ceramic aluminum oxide, heat treated aluminum oxide, alumina zirconia, silicon carbide, iron oxides, tantalum carbide, cerium oxide, garnet, titanium carbide, synthetic and natural diamond, zirconium oxide, silicon nitride, or combinations thereof.

7. The scouring article of claim 1, wherein the organic abrasive particles comprise at least one of melamine-formaldehyde resin, phenolic resin, polymethyl methacrylate, polystyrene, polycarbonate, certain polyesters and polyamides, and the like, or combinations thereof.

8. A method of making a scouring article, comprising the steps of:
(a) coating a lofty non-woven substrate with an abrasive slurry comprising:
a binder;
a first plurality of inorganic abrasive particles having a Mohs' hardness of 7 greater or dispersed in said binder, wherein the abrasive particles have a median particle size of in the range of 20 microns to 100 microns; and
a second plurality of organic abrasive particles having a Mohs' hardness in the range of 1 to 5 dispersed in the binder, wherein the organic abrasive particles have a median particle size greater than 100 microns; and
(b) subjecting the abrasive slurry to conditions sufficient to at least partially cure the binder;
wherein the average surface roughness created by use of the scouring article, according to the surface roughness test, is less than 8 microns.

9. A roll comprising a three-dimensional non-woven web of fibers bonded to one another to form a lofty, non-woven substrate;
an abrasive coating on the substrate, the abrasive coating comprising:
a binder;
a first plurality of inorganic abrasive particles having a Mohs' hardness of 7 greater or dispersed in said binder, wherein the abrasive particles have a median particle size in the range of 20 microns to 100 microns; and
a second plurality of organic abrasive particles having a Mohs' hardness in the range of 1 to 5 dispersed in the binder, wherein the organic abrasive particles have a median particle size greater than 100 microns;
wherein the substrate is wound about itself to form a roll; and wherein the substrate is perforated across its width at regular intervals such that a section of the substrate can be removed from the remainder of the substrate and used as a single scouring pad.
